(19) United States
(12) Patent Application Publication
(10) Pub. No.: US 2014/0084519 A1
(43) Pub. Date: Mar. 27, 2014

(54) METHODS AND A MOLD ASSEMBLY FOR FABRICATING POLYMER STRUCTURES BY IMPRINT TECHNIQUES

(71) Applicants: Fondazione Istituto Italiano di Tecnologia, Genova (IT); STMicroelectronics S.r.l., Agrate Brianza (IT)

(72) Inventors: Fabrizio Porro, Portici (NA) (IT); Antonio Scognamiglio, S. Giorgio a Cremano (NA) (IT); Raffaele Vecchione, Napoli (IT); Valeria Casuscelli, Napoli (IT); Andrea Di Matteo, Napoli (IT); Luigi Giuseppe Occhipinti, Ragusa (IT); Paolo Netti, Napoli (IT)

(73) Assignees: Fondazione Istituto Italiano di Tecnologia, Genova (IT); STMicroelectronics S.r.l., Agrate Brianza (IT)

(21) Appl. No.: 14/030,888

(22) Filed: Sep. 18, 2013

(30) Foreign Application Priority Data
Sep. 21, 2012 (IT) VI2012A 000230

(51) Int. Cl. B29C 59/02; B29C 59/00

(52) U.S. Cl. CPC B29C 59/02; B29C 59/002
USPC 264/447; 264/219; 264/220; 425/385

(57) ABSTRACT

The present disclosure relates to mold components and imprint lithography techniques applied on the basis of organic mold materials in order to form polymer microstructure elements. It has been recognized that adapting surface characteristics of at least one mold component may significantly enhance performance of the lithography process, in particular with respect to suppressing residual polymer material, which in conventional strategies may have to be removed on the basis of an additional etch process.

### BACKGROUND

1. Technical Field

Generally described, the present disclosure relates to the field of fabricating miniature polymer structures using imprint lithography and in particular nano imprint lithography (NIL).

2. Description of the Related Art

The fabrication of isolated structures of reduced size is an important aspect in many technical fields, such as photonics, electronics, medical drug production, tissue engineering, and the like. To this end, a plurality of production techniques have been developed in order to provide structures of a plurality of desired materials with dimensions in the range of micrometers and in recent developments down to a few nanometers. These structures of minimal dimensions in the range of several hundred micrometers to several nanometers, which will hereinafter be referred to as “microstructures”, irrespective of the actual lateral dimensions thereof, are typically formed on the basis of lithography techniques, in which a pattern of a lithography mask is optically imaged into an appropriate radiation sensitive material in order to form a latent image therein, which is subsequently developed so as to provide a mask for the further patterning of an underlying material. “Non-contact” lithography techniques are often non compatible with materials to be patterned and they also suffer from significant challenges in terms of process complexity and thus production cost, in particular when considering the fabrication of microstructures having lateral dimensions significantly below the wavelength of the exposure radiation used. These drawbacks are nowadays increasingly overcome by using so-called imprint lithography techniques. The imprint lithography technique usually benefits from the provision of a template that may be brought into direct contact with a deformable material so as to transfer the pattern of the template into the deformable material, thereby obtaining a desired microstructure in the deformable material. Depending on the overall process strategy the deformable material may then be used as a further template or may itself represent the final material of the microstructure of interest. Frequently the template may be provided in the form of a mold, in which at least a first part may have formed therein the desired pattern, which may be filled with a desired material to be patterned, wherein a “closed” mold assembly may be formed by completing the first part and the material contained therein with a second complementary part, which is specifically adapted in size, material and shape to the first part of the mold assembly. This concept is typically applied upon fabricating desired polymer or polymer patterns on the basis of imprint lithography. That is, the transfer of the desired pattern from the mold assembly to the polymeric precursor material is accomplished by forming the precursor material between the first and second mold parts and applying appropriate pressure and temperature conditions in a controlled and uniform manner across the entire mold assembly. In particular when fabricating microstructures on the basis of a polymer material the use of soft, elastomeric materials as base materials for the mold is highly advantageous, since frequently such materials are transparent to ultraviolet (UV) radiation, which allows radiation sensitive materials to be used in order to allow or enhance the imprint process when processing a polymeric material. Furthermore, such soft elastomeric materials may have a very low elastic modulus, thereby imparting flexibility to the mold in order to provide conformal contact between the mold parts irrespective of any surface irregularities that may be present, for instance, in the complementary mold part. Furthermore, the flexibility of the mold parts simplifies the release of the mold parts upon forming the mold on the basis of a highly rigid master template and imparts high durability of mold for long life time and superior process cyclability. For example, polydimethyl siloxane (PDMS) is a frequently used base material for fabricating molds, which are used for the fabrication of microstructures on the basis of imprint lithography.

The typically applied process of fabricating polymer microstructures by means of imprint lithography, however, does not necessarily result in the formation of the desired structure, but may also create an undesired residual polymer layer, which is also referred to as a scum layer. This undesired residual polymer layer may form a connection between individual structure elements, which should not be mechanically coupled, thereby causing an additional process step for removing the undesired connections between individual structure elements. Frequently, a corresponding plasma-based etch process is applied in order to remove the residual polymer layer, thereby causing additional negative side effects in terms of overall production costs and throughput. Furthermore, the etch process typically also affects the structure elements for example by modifying the shape, thickness, roughness and generally the surface chemistry of these elements. Other approaches make use of PFPE (Perfluoropolyether) molds which might have right surface energy to avoid formation of scum layer with some process materials. However due to its brittleness PFPE has low durability and can only be used with a restricted number of materials which can match with its surface energy.

### BRIEF SUMMARY

Generally described, the present disclosure provides techniques and mold assemblies or parts thereof, which may be used for fabricating polymer-based microstructures, wherein an appropriate adaptation of the surface characteristics of at least one mold part may result in the avoidance or at least significant reduction of a residual polymer layer upon performing an imprint lithography process, i.e., upon performing a process for forming a polymer microstructure by using an elastomeric mold assembly. Due to the ability to tune the surface energy of the mold assembly, in this disclosure the patterning of a large number of polymer materials is made possible as compared to other known alternatives, which are limited to the bulk properties of the mold material.

According to one aspect of the present disclosure there is provided a method comprising applying a surface treatment to a surface of at least one of a first mold part made of a first organic material and a second mold part made of a second organic material, wherein the surface treatment results in a target surface energy of said first and/or second mold parts with respect to a polymer material to be formed from a polymeric precursor material. The method further comprises filling the first and/or second mold parts with the polymeric precursor material. Furthermore, the method comprises forming a mold assembly from the first and second mold parts and the polymeric precursor material. The method additionally comprises removing the first and second mold parts after curing the polymeric precursor material so as to provide a polymer micro-structure comprised of the polymer material.

According to present disclosure well-established organic materials, such as PDMS, may be used as molds for performing an imprint lithography process, wherein, however, contrary to conventional strategies a surface treatment is applied in order to appropriately adjust the surface energy, thereby enabling an efficient control of the lithography process, in particular with respect to the migration of polymer material and/or polymer precursor material when performing the imprint process. Hence, in particular microstructures of reduced dimensions may be formed with a significantly reduced degree of residual polymer material, thereby contributing to superior pattern fidelity of the resulting microstructure. On the other hand, the mold assembly comprised of organic materials may nevertheless allow a high number of a replication processes to be performed that is comparable to rigid templates due to the appropriately adjusted surface characteristics and optimal mechanical properties, while nevertheless providing the advantages associated with the usage of organic mold materials.

For example, in one illustrative embodiment applying the surface treatment comprises reducing wettability of the surface of at least one of the first and second mold parts. For example, the adjustment of wettability of one or more of the surface areas of interest of the mold assembly enables the adjustment of a desired ratio of surface energy between the first and second mold parts and the polymer material to be formed. In this manner, an improved distribution of the precursor material is accomplished during the imprint process, thereby substantially preventing the formation of a residual material layer.

In one illustrative embodiment applying the surface treatment comprises forming a hydrophobic surface layer by initiating a reaction of hydroxyl groups and perfluorinated ethoxy alkyl silanes. In this manner well-established chemical reagents and techniques may be applied in order to adjust the surface characteristics.

In a further illustrative embodiment applying the surface treatment comprises performing a process so as to create and/or activate hydroxyl groups on the surface. That is, any appropriate process may be applied, for instance an ion bombardment in the context of a plasma treatment, and the like, in order to prepare the surface for the subsequent reaction with molecules of perfluorinated ethoxy alkyl silanes. Consequently, in total 2 or more process steps are available, in which the finally desired surface characteristics may efficiently be controlled, since, for instance, the type of reaction molecules, one or more process parameters of the process of preparing the surface prior to the application of the reaction molecules, and the like may represent efficient control parameters. For example, well-established strategies for a plasma treatment on the basis of an oxygen ambient are available and may be used for activating and/or generating hydroxyl groups at the surface areas of interest. On the other hand, these process steps are carried out prior to forming the actual polymer microstructure or depositing the precursor material so that undue interaction of these pre-imprint processes with the sensitive materials is avoided.

In one preferred embodiment the first organic material is polydimethyl siloxane (PDMS). Consequently, well-established strategies may be used for providing the precursor materials for the mold assembly in order to obtain the PDMS parts, for instance based on a rigid template made of silicon, and the like, by using any advanced lithography technique, wherein the high degree of transparency of PDMS with respect to UV radiation enables the fabrication of polymer structures based on radiation curable precursor materials. In this manner, the variety of materials, which can be used for forming polymer microstructures, is significantly increased with respect to other mold materials such as PFPE, thereby enabling a fine tuning of mechanical, electrical, biocompatibility and biodegradability properties of the final polymeric microstructures. For example, by allowing the usage of a wide variety of precursor materials the polymer microstructures may be designed to be used in many industrial applications ranging from drug delivery to tissue engineering and plastic electronics.

In some illustrative embodiments the second organic material differs from the first organic material, thereby providing for additional flexibility in designing the mold assembly. For example, the second mold part may be provided as a substrate made of PET, and the like, that is matched in size and shape to the first mold part, which may be made of PDMS.

During the imprint lithography process, an appropriate pressure ranging from room pressure to approximately 20 Bar, preferably from room pressure to 10 bars, at a temperature ranging from room temperature to 250° C., depending on material to be processed, may be applied so as to provide for a high degree of compatibility with well-established process environments that may be established in the context of micro-fabrication techniques. Due to the superior surface characteristics and due to the general superior characteristics of elastomeric mold parts significant improvement with respect to production yield may be achieved on the basis of the above identified process parameters, while also a reduction of overall costs may result due to the possibility of the avoidance of additional complex post-lithography process steps, such as plasma etching techniques, which are conventionally utilized for addressing the problem of residual material layers when forming polymer microstructures on the basis of elastomeric mold materials.

As previously discussed, in some illustrative embodiments the step of curing the polymeric precursor material comprises exposing the polymeric precursor material to UV radiation, which results in a highly efficient lithography process for radiation sensitive materials, wherein at least one mold part is substantially transparent for the UV radiation.

According to a further aspect of the present disclosure there is provided a method of forming a mold part. The method comprises preparing an organic precursor material and casting the organic precursor material on a rigid master template having formed therein a microstructure to be replicated. Additionally, the method comprises curing the organic precursor material so as to form a polymer mold part. Furthermore, the rigid master template is removed from the polymer mold part. Moreover, the method comprises adapting wettability of a surface of the mold part with respect to a second mold part and to a polymer material to be formed in the mold part by performing a surface treatment.

As discussed above, in this aspect of the present disclosure the surface treatment for adapting wettability of the mold part may efficiently be incorporated into the manufacturing process for forming the mold part, thereby obtaining the mold part so as to exhibit desired surface characteristics, which may specifically be designed with respect to the polymeric microstructure to be formed. For example, wettability of the surface may efficiently be reduced on the basis of initiating a chemical reaction so as to establish chemical bonds between hydroxyl groups and appropriate molecules, thereby providing a highly hydrophobic surface. The degree of surface modification may appropriately be determined and then adjusted on the basis of well-established measurement techniques, such as the measurement of the water contact angle, which describes the relationship between surface tension of water, polymer material and air. Hence, the water contact angle may readily be used as a measure to determine appropriate parameters for the surface treatment with respect to any precursor material to be processed with the mold part under consideration.

Hence, in one illustrative embodiment performing the surface treatment comprises forming a hydrophobic surface layer on a surface of the mold part by initiating a reaction of hydroxyl groups provided on the surface and perfluorinated ethoxy alkyl silanes, thereby allowing the application of well-established chemicals for providing a surface of reduced wettability.

To this end, any appropriate process may be performed so as to create and/or activate the hydroxyl groups on the surface, thereby increasing flexibility and controllability of the surface treatment, as is also discussed above. For example, an oxygen plasma process may be used in order to appropriately prepare the surface prior to applying the desired type of molecules that will finally form a substantially mono-molecular layer.

According to still a further aspect of the present disclosure there is provided a mold assembly configured to form a polymer microstructure. The mold assembly comprises a first mold part comprised of a first organic material and having a first surface. The mold assembly further comprises a second mold part comprised of a second organic material and having a second surface, wherein the first and/or the second surface have formed thereon a hydrophobic surface layer providing proper contact angle as to suppress residual polymer material during imprinting, such as a water contact angle of 130° or higher.

Consequently, the mold assembly of the present disclosure provides surface characteristics that result in a significantly reduced wettability compared to conventional organic mold materials, as indicated by the moderately high water contact angle, so that in particular polymeric precursor materials may efficiently be processed in the mold assembly, while avoiding or at least significantly reducing the occurrence of any unwanted residual polymer material layers, which in conventional strategies benefit from additional post-lithography treatments in the form of etch processes, and the like.

As discussed above, in particular surface characteristics may efficiently be determined and objectively measured on the basis of the water contact angle, thereby also enabling an efficient adjustment of the final target surface characteristics in an objective and reproducible manner.

In one preferred embodiment the mold assembly of the first and/or the second mold parts are made of PDMS.

### BRIEF DESCRIPTION OF THE SEVERAL VIEWS OF THE DRAWINGS

Further illustrative embodiments of the present disclosure are also defined in the appended claims and in the description, which is to be studied in the context of the drawings, in which:

FIG. 1 schematically illustrates an optical microscopy photo of a polymer microstructure formed on the basis of an elastomeric mold material in a conventional strategy, thereby resulting in a residual polymer material layer;

FIGS. 2a to 2g schematically illustrate cross-sectional views of a mold part during a manufacturing process, in which superior surface characteristics are imparted to a mold part in accordance with illustrative embodiments of the present disclosure;

FIG. 2h schematically illustrates the results of a water contact angle measurement in order to specify the surface characteristics of a surface of a mold part formed on the basis of the principles of the present disclosure in comparison with a conventionally fabricated mold part;

FIG. 2i schematically illustrates a cross-sectional view of a mold assembly with superior surface characteristics so as to form a polymer microstructure in accordance with illustrative embodiments of the present disclosure; and

FIG. 2j schematically illustrates an optical microscopy photo of the resulting polymer microstructure obtained on the basis of the process strategy illustrated in FIG. 2i.

### DETAILED DESCRIPTION

With reference to the accompanying drawings further illustrative embodiments of the present disclosure will now be described in more detail.

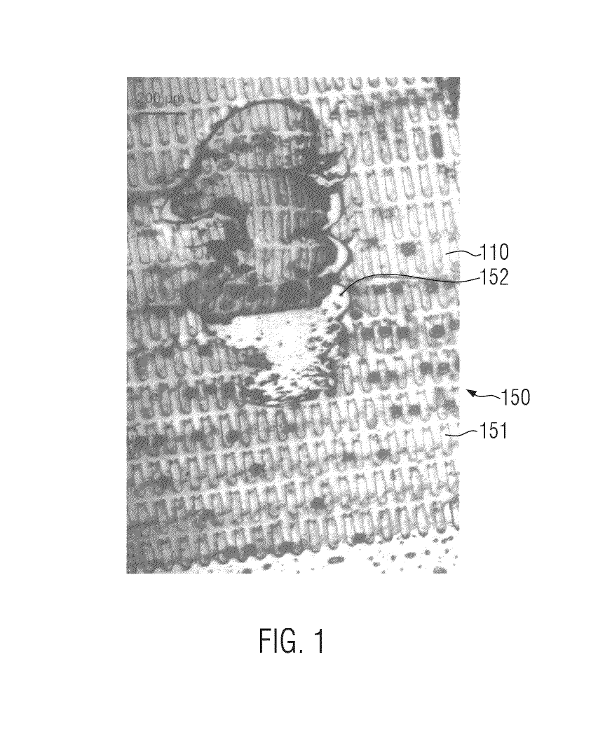

FIG. 1 schematically illustrates a polymer microstructure 150, which may comprise a plurality of individual structure elements 151, for instance provided in the form of rectangular elements with lateral dimensions. As discussed above, the lateral dimensions of the individual structure elements 151 may reach from several hundred micrometers to 20 nm and even less, depending on the specific application. It should be appreciated, however, that the elements 151 may have any other geometric configuration. In the example shown, the elements 151 should be provided as independent elements. As discussed above, however, although the application of imprint lithography techniques may, in principle, be highly advantageous, nevertheless, significant portions of residual polymer material 152 may typically be observed after separating the mold parts. For convenience, a mold part 110, which may be provided in the form of a substrate, is illustrated, while the other mold part, which actually has implemented therein the pattern for forming the microstructure 150, is not shown. As evident from FIG. 1, many of the structure elements 151 cannot be removed as separate components from the mold part 110 without applying additional processes, such as an etch process, and the like, thereby contributing to additional complexity and costs of the overall manufacturing process. Furthermore, the etch process may also significantly modify the characteristics of the elements 151 and of the mold part 110. For example, size and shape as well as surface characteristics of the elements 151 may significantly be negatively affected by a plasma-based etch process that is used for removing the residual layer 152.

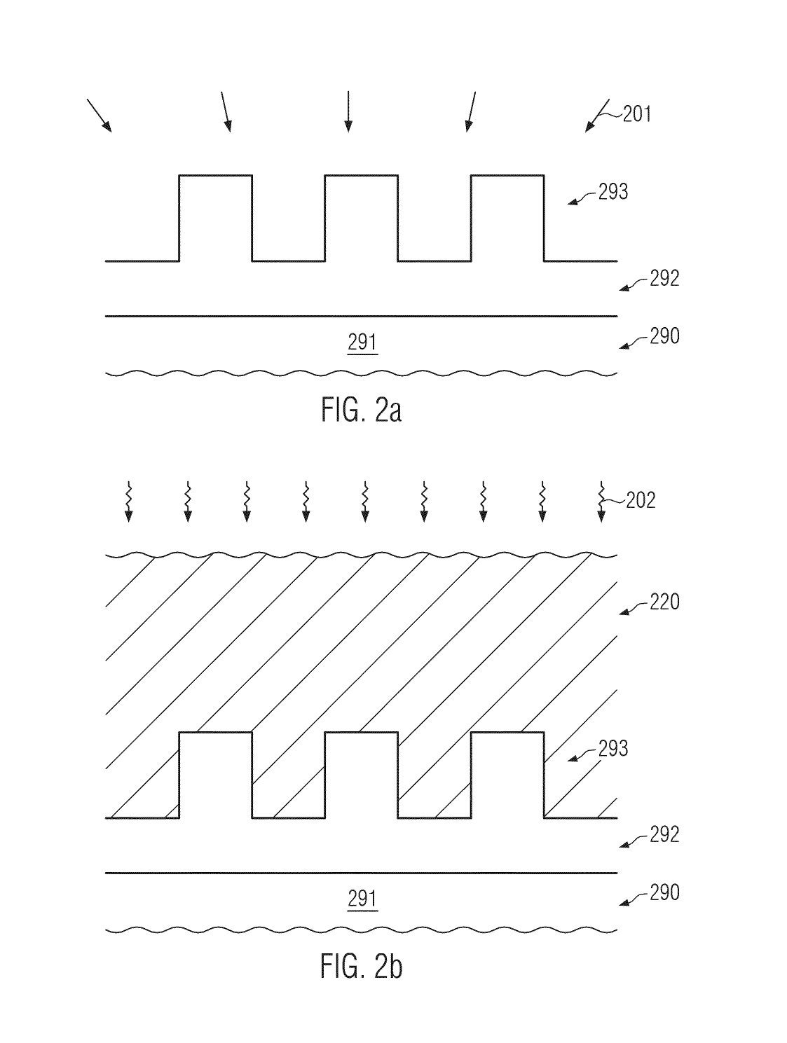

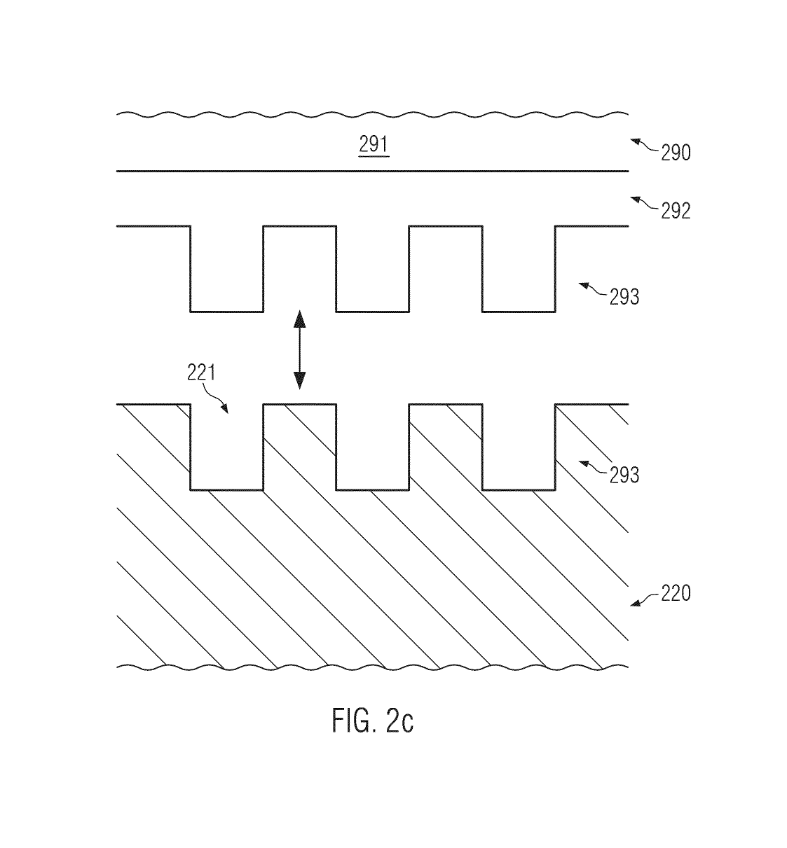

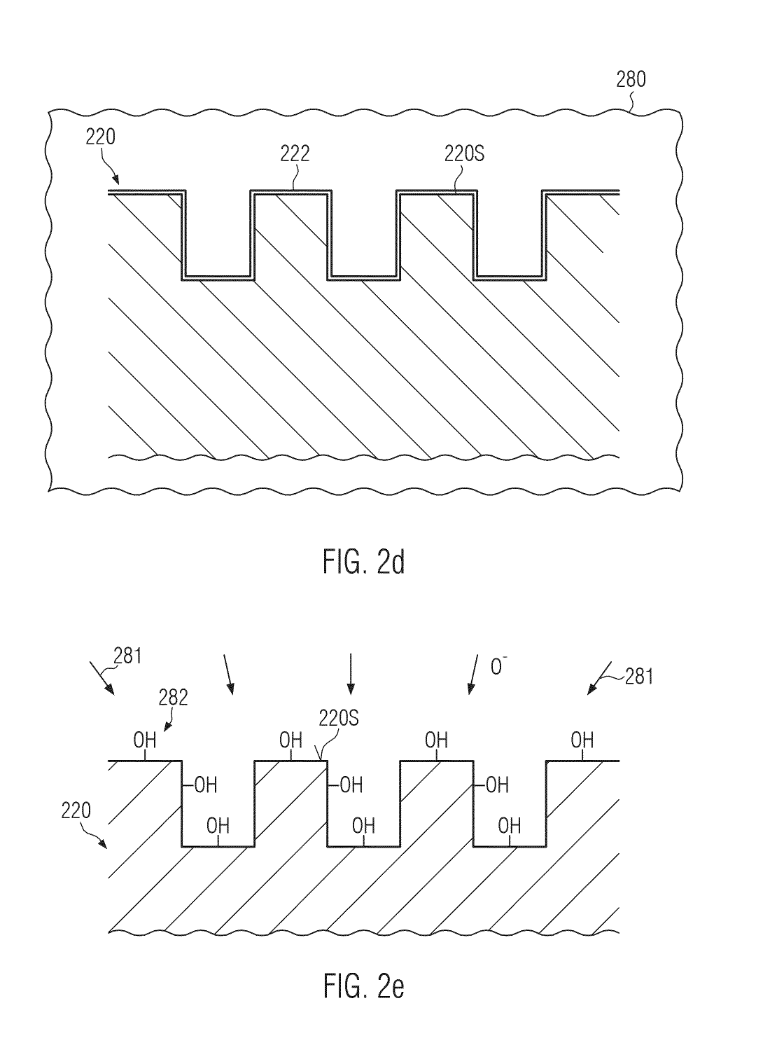

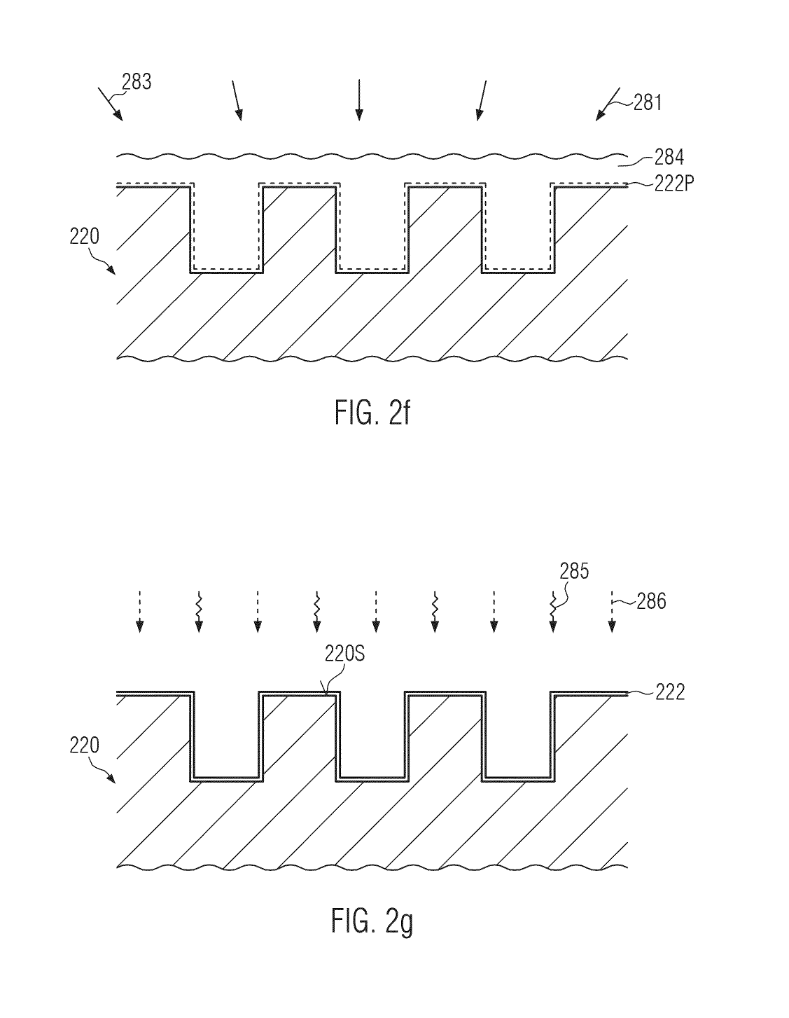

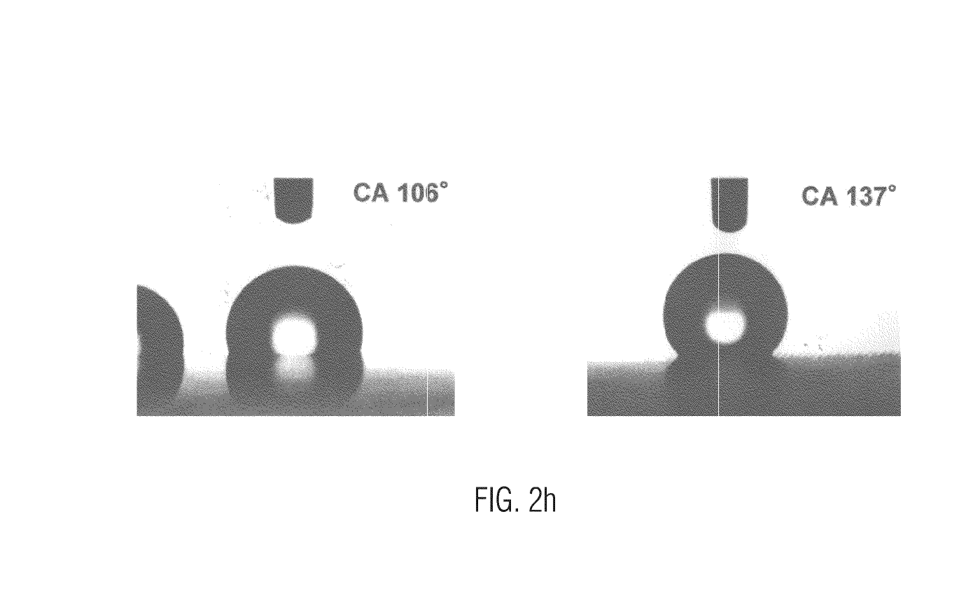

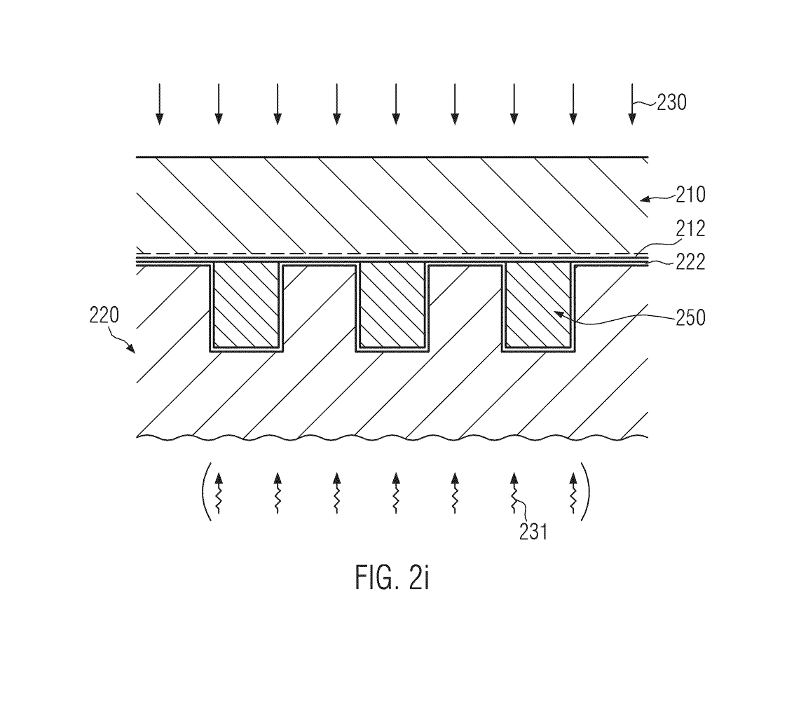

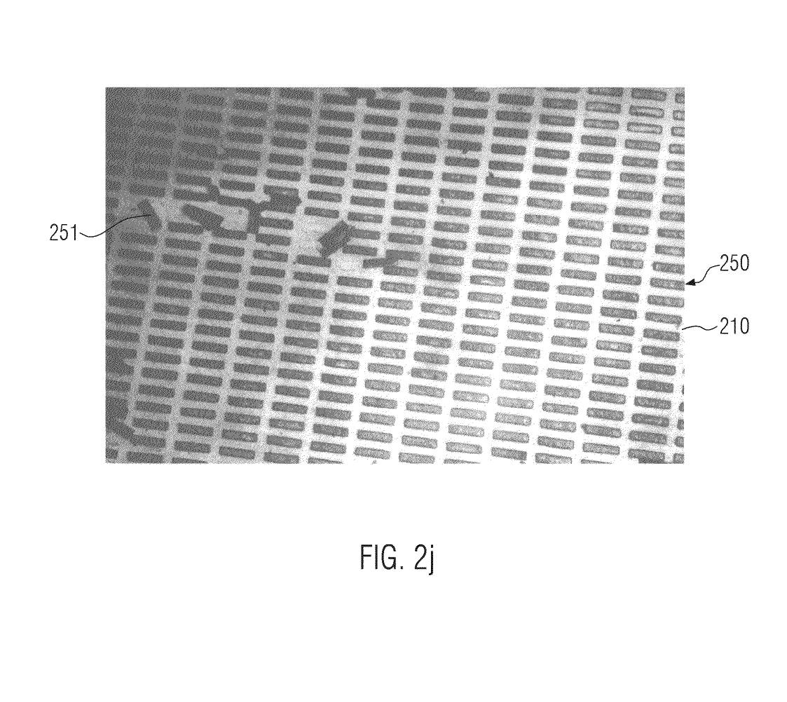

With reference to FIGS. 2a to 2h a manufacturing process will now be described in more detail, in which mold parts of a mold assembly are formed on the basis of an organic material, wherein superior surface characteristics are imparted to at least one of the mold parts in order to avoid additional post-lithography process steps utilized in the conventional strategy for removing the residual layer 152 as discussed above with reference to FIG. 1.

FIG. 2a schematically illustrates a cross-sectional view of a rigid template 290, which may be used as a master template for forming a mold part of elastomeric material. The template 290 may comprise any appropriate rigid substrate material 291, which may include an appropriate material layer 292, in which a desired microstructure 293 may be formed on the basis of available lithography techniques, such as optical lithography, electron beam lithography, and the like. For example, at least the layer 292 may be provided in the form of silicon, silicon dioxide, silicon nitride, and the like, while the substrate 291 may be any appropriate substrate material. It should be appreciated, however, that the substrate 291 and the layer 292 may be made of the same material in some approaches. Due to the rigidity of the template 290, a direct usage of the template 290 for forming a plurality of replica of a polymer microstructure may result in poor pattern fidelity and significant production costs.

Therefore, the template 290 may efficiently be used for forming an elastomeric mold assembly, which may be accomplished by using well-established precursor materials in order to obtain a flexible mold. In one illustrative embodiment, at least one mold part may be formed from PDMS material, which may be accomplished by selecting an appropriate precursor material, such as Sylgard 184 kit-Base, in combination with a curing agent that is appropriate for the afore-indicated precursor material. The curing agent and the precursor material may be prepared with a ratio of 1:10 in terms of weight percent. Thereafter, the mixture may be degassed in a dryer under vacuum conditions. The resulting substance, schematically indicated by 201 in FIG. 2a may then be applied on the master template 290 on the basis of any appropriate deposition technique. It should be appreciated that only a portion of the template 290 is illustrated in FIG. 2a, while actually many more structure elements are typically provided in the structure to be formed.

FIG. 2b schematically illustrates a cross-sectional view of the resulting assembly, in which a pre-form of a mold part 220 is shown to be positioned on the master template 290. In this stage, any appropriate curing process, for instance a thermal curing at 100° C. for 30 min, is applied so as to obtain the desired final characteristics of the base material of the mold part 220.

FIG. 2c schematically illustrates the mold part 220 having formed therein a pattern 221, which corresponds to the pattern of the master template 290. In the stage shown, the mold part 220 is separated from the master 290, which may be accomplished on the basis of any well-established process techniques.

FIG. 2d illustrates the mold part 220 when subjected to a surface treatment, which is schematically illustrated as 280, in which appropriate surface characteristics are imparted to the exposed surface areas 220S of the mold part 220. As previously discussed the surface tension and thus wettability have been recognized as very important properties of a mold, for instance a mold made of PDMS. Due to the treatment 280 these surface properties can be appropriately adapted to the specific materials to be formed as liquids or solids by employing the mold, wherein also the surface characteristics of the other mold part, which may be planar or also patterned (in case microstructure features are wanted on both sides of the processed polymer). This is otherwise appropriately adapted to the mold part 220 and thus represents a complementary mold part for forming a mold assembly, may be taken into consideration or may also be adjusted on the basis of a surface treatment. That is, surface migration of the material to be processed in the mold assembly is significantly affected by its surface tension, which in turn is dependent on the surface energy of the mold material and the interface energy between the material to be processed and the surface of the mold. Hence, by specifically adapting the surface characteristics of at least one mold part with respect to the remaining components superior behavior during the imprint lithography process may be achieved, for instance by avoiding or at least significantly reducing the formation of a residual material layer.

For example, when performing the surface treatment 280 a surface layer 222 is formed, for instance in the form of a mono-molecular layer comprised of appropriately selected molecules, which substantially determine the resulting surface characteristics. For example, molecules of the family of triethoxy silane perfluoroethers, such as Fluorolink S10 produced by Solvay Solexis, dissolved in an alcoholic solvent, such as isopropyl alcohol, may be used, since such molecules efficiently react with the hydroxyl groups present on the surface 220S, thereby creating a hydrophobic surface layer, such as the layer 222. Hence, the surface tension is significantly reduced compared to the surface tension of the non-treated base material of the mold part 220. Furthermore, using an alcoholic solvent for initiating the chemical reaction of the molecules with the hydroxyl groups may allow the usage of elastomeric materials, such as PDMS, since this material does not undergo any relevant swelling in the alcohol so that the pattern defined in the surface of the component 220 is preserved.

It should be appreciated that the surface treatment 280 may be controlled so as to obtain a desired degree of surface modification on the basis of the layer 222 for the further processing of an appropriate precursor material in combination with a complementary mold part, which may also come into contact with surface areas of the mold part 220.

With reference to FIGS. 2e to 2g illustrative embodiments of the surface treatment 280 will now be described in more detail. Some of these process steps may be similar to process techniques as are also described in US patent application 2011/0006032, wherein, however, in this case adhesion of metal layers is to be improved, rather than adjusting appropriate surface characteristics with respect to improving an imprint lithography process.

FIG. 2e schematically illustrates the mold part 220 according to illustrative embodiments, in which a process 281, such as a plasma process based on an oxygen ambient, may be performed prior to actually applying appropriate molecules in order to prepare or condition the surface areas 220S. During the process 281 additional hydroxyl groups may be created in the surface 220S or respective hydroxyl groups may be “activated”, i.e., these groups may be provided so as to be available as dangling bonds in order to provide appropriate conditions for forming covalent chemical bonds with molecules still to be applied. Furthermore, during the process 281 contaminants may efficiently be removed, thereby also providing for superior process conditions during the subsequent surface modification process.

It should be appreciated that an oxygen-based plasma may be performed on the basis of well-established process recipes, wherein the control of process parameters, such as high frequency power, low frequency power, pressure, and the like may allow an efficient control of the resulting surface conditions, which in turn may affect the further processing, thereby providing for an additional control mechanism in adjusting the finally desired surface characteristics.

FIG. 2f schematically illustrates a surface treatment 283 designed to form a surface layer imparting the desired surface characteristics to the base material of the mold part 220. In this embodiment, the treatment 283 includes the application of an appropriate mixture, which comprises appropriate molecules that may react with hydroxyl groups in the surface of the mold part 220. In this embodiment the surface modification includes the initiation of a covalent bonding of perfluorinated ethoxy alkane silanes with the hydroxyl groups formed on the surface of the mold part 220 made of PDMS. To this end the following formulations may be used:

(CH₃CHO)₃SiO(CF₂CF₂O)m(CF₂O)nCF₃;

(CH₃CHO)₃SiO(CF(CF₃)CF₂O)m(CF₂O)nCF₃;

(CH₃CHO)₃SiO(CF(CF₃)CF₂O)mCF₂CF₃; or

(CH₃CHO)₃SiO(CF₂CF₂CF₂O)mCF₂CF₃.

The solution may be prepared, for instance by using the following standard composition from the datasheet of Fluorolink 10, thereby obtaining the resolution of the silanizing agent (the percentages are expressed in weight percent):
0.1-1.0% Fluorolink S10;
0.4-4.0% acqua (4/1 ratio water/Fluorolink S10);
0.1-1.0% acetic acid or HCl 10% (1/1 ratio acetic acid/Fluorolink S10) and
99.4-94.0% isopropyl alcohol.

At least 30 min after preparing this solution, denoted as 284, the mold part 220 is immersed in this solution for a few seconds, or alternatively the solution is applied with any other appropriate deposition technique. For example, as shown in FIG. 2f, during the treatment 283 the solution 284, for instance as prepared in the above-discussed manner, is applied to exposed surface areas of the mold part 220, for instance comprised of PDMS, which are thus covered by the solution 284. During the contact of the exposed surface areas and the solution 284 perfluorinated ethoxy alkane silanes form a layer 222P of defined thickness.

FIG. 2g schematically illustrates the mold part 220 during a curing process 285, for instance performed at approximately 100° C. for approximately 60 min, wherein chemical bonds are formed between the molecules of the layer 222P and the hydroxyl groups on the surface 220S. Due to this reaction mechanism a self-assembled molecular monolayer, i.e., the layer 222, is formed.

Thereafter, a further process step 286 may be applied, in which ultrasonic energy is used in combination with isopropanol and water in order to remove excess reagents, thereby providing the configuration as shown in FIG. 2g.

It should be appreciated that process parameters as well as type of fluorinated molecules of the above described process steps may readily be determined on the basis of experiments so as to obtain desired surface characteristics, i.e., characteristics of the layer 222 for the further usage of the mold part 220.

FIG. 2h schematically illustrates measurement results of the surface characteristics of the mold part 220 after forming the layer 222, as discussed above. In the right-hand portion of FIG. 2h the water contact angle of the mold part 220 is determined to be 130° or greater, for instance about 137°, thereby indicating a significantly reduced wettability of the surface of the mold part 220 due to the presence of the surface layer 222. In comparison, the left-hand portion of FIG. 2h illustrates the same measurement procedure for a substantially identical mold part, which, however, lacks the surface layer 222 and thus represents a PDMS mold part formed in accordance with conventional strategies. Hence, a significant increase of the water contact angle may be achieved, which imparts the desired reduced wettability to the surface of the mold part 220.

On the basis of the mold part 220 having the superior surface characteristics corresponding polymer microstructures may be formed according to any appropriate imprint lithography technique.

With reference to FIGS. 2i and 2j a corresponding process sequence as described, wherein as an example a polymeric material in the form of polyethylene glycol diacrylate (PEDGA, 700 Da, Sigma Aldrich) is to be formed as a microstructure by using a mold assembly having a first mold part comprised of PDMS, such as the mold part 220 previously described, and an appropriate second mold part as a complementary or matched mold part, for instance provided as a layer of polyethylene terephtalat (PET).

FIG. 2i schematically illustrates a cross-sectional view of a mold assembly 200 comprising the mold part 220, which, in one illustrative embodiment, comprises the surface layer 222 in order to provide superior surface characteristics, as discussed above. Moreover, a second mold part 210, for instance comprised of PET, may act as a complementary part for defining a microstructure 250 to be formed from any appropriate precursor material. It should be appreciated that the second mold part 210 may also comprise a modified surface layer 212, if the material characteristics of the material to be processed in the mold assembly 200 are considered to utilize modified surface characteristics for both the part 210 and the part 220. It should be appreciated, however, that in other cases it may be sufficient to provide one of the mold parts 210 and 220 with superior surface characteristics, while still achieving superior overall performance upon forming the microstructure 250.

For example, if the modified surface layer 212 is formed on exposed surface areas of the mold part 210, a similar process sequence may be applied as described above with reference to the mold part 220.

As an example, a mixture of 78% PEGDA, 20% water and 2% photo-initiator DAROCURE was prepared upon forming the microstructure 250.

This liquid precursor material may be filled into the mold part 220 by using any appropriate deposition technique, with the mold part 210 being provided on top, for instance by applying slight pressure so as to remove any excess portion of the liquid precursor material.

The resulting mold assembly 200 including the precursor of the microstructure 250 may then be placed in an appropriate process ambient so as to perform the imprint lithography process 230. To this end, for example, a pressure of 500,000 Pascal or higher may be applied for a defined process time so as to initiate the polymerisation of the precursor material in order to obtain the desired polymer material of the microstructure 250. For example, in one illustrative embodiment, a pressure of approximately 900,000 Pascal is applied for 30 seconds, wherein upon pertaining the pressure an additional exposure 231 to UV radiation for 120 seconds may be used. These process steps may be carried out at room temperature, thereby obtaining the desired characteristics of the polymer material. It should be appreciated that exposure to UV radiation is made possible due to the high degree of transparency of the mold part 220 with respect to UV radiation.

It should further be noted that any other process recipes may be applied during the imprint lithography process 230, depending on the precursor material used and the finally desired characteristics of the microstructure 250.

Due to the specifically adapted surface characteristics of at least one of the components of the mold assembly 200 the removal of excess material of the precursor liquid of the microstructure 250 may be enhanced compared to conventional process techniques, thereby avoiding undue material residues in the microstructure 250 after polymerisation of the liquid precursor material during the imprint step 230. Furthermore, the mold parts 220, 210 may be separated very efficiently due to the enhanced surface characteristics, thereby also facilitating the imprint process 230, 231 compared to conventional strategies.

FIG. 2j schematically illustrates an optical microscopy photo of the resulting microstructure 250, which is still formed on the mold part 210. As shown, a plurality of structure elements 251 may be provided having basically the same lateral dimensions as previously discussed with reference to FIG. 1. Contrary to the conventional situation, however, due to the superior surface characteristics the formation of a residual layer or scum layer may be suppressed so that the structure elements 251 may still be individual independent particles. For convenience, some of the elements 251 have been mechanically released from the mold part 210 in order to demonstrate the lack of any scum layer. Consequently, the structure elements 251 may be obtained as individual elements without any further post-lithography treatment, as is typically utilized in conventional process strategies, as discussed with reference to FIG. 1.

As explained before, depending on the polymer material to be used for forming the microstructure 250 a surface treatment may be applied to the mold part 220, the mold part 210 or both mold parts. The surface treatment of the present disclosure is non-invasive even for critical base materials, such as PDMS, since exclusively alcoholic solvents are used. Consequently, the surface treatments described above may be applied to a wide range of organic substrate material substantially without changing the original dimensions of the structure elements 251, which are determined by the dimensions of the master template used to form the mold part 220, as discussed above. That is, the chemical physical surface treatment preserves, due to the non-invasive nature, the original pattern of the microstructure to be formed, and enables a target ratio of surface energies between the material to be printed and the mold components to be adjusted. In this manner, the surface characteristics in combination with appropriate pressure and temperature conditions allow suppression of polymeric residues between independent features (scum layer). Consequently, many types of microstructures may be formed on the basis of imprint lithography using elastomeric mold components, wherein in particular microparticles of desired size and shape may be provided for a wide variety of polymer materials based on organic mold assemblies with high production yield and reduced overall process complexity compared to conventional strategies.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
applying a surface treatment to a surface of at least one of a first mold part made of a first organic material and a second mold part made of a second organic material, said surface treatment resulting in a reduced surface tension of said at least one of the first and second mold parts compared to a surface tension of the other of the first and second mold parts;
filling at least one of said first and second mold parts with said polymeric precursor material;
forming a mold assembly from said first and second mold parts and said polymeric precursor material;
curing said polymeric precursor material; and
exposing a polymer microstructure that includes said polymer material by removing at least one of said first and second mold parts after curing said polymeric precursor material.

2. The method of claim 1, wherein applying said surface treatment comprises reducing wettability of said surface of at least one of said first and second mold parts.

3. The method of claim 1, wherein applying said surface treatment comprises forming a hydrophobic surface layer by initiating a reaction of hydroxyl groups and perfluorinated ethoxy alkyl silanes.

4. The method of claim 1, wherein applying said surface treatment comprises at least one of creating and activating hydroxyl groups on said surface.

5. The method of claim 4, wherein said at least one of creating and activating is implemented as a particle bombardment in an oxygen containing ambient.

6. The method of claim 1, wherein said first organic material is an elastomeric polymer.

7. The method of claim 6, wherein said elastomeric polymer is polymethyl siloxane (PDMS).

8. The method of claim 6, wherein said second organic material differs from said first organic material.

9. The method of any of claim 1, further comprising applying a pressure ranging from room pressure to 20 Bar and at a temperature ranging from room temperature to 250° C.

10. The method of any of claim 1, wherein curing said polymeric precursor material comprises exposing said polymeric precursor material to UV radiation.

11. The method of claim 1, wherein said polymer microstructure is harvested from said second mold part.

12. The method of claim 1, wherein said polymer microstructures is left on said the second mold part.

13. A method of forming a mold part, said method comprising:
preparing an organic precursor material;
casting said organic precursor material on a rigid master template having formed therein a microstructure to be replicated;
forming a polymer mold part by curing said organic precursor material
removing said rigid master template from said polymer mold part; and
adapting wettability of a surface of said mold part, with respect to a second mold part and to a polymer material to be formed in said mold part, by treating said surface of said mold part.

14. The method of claim 13, wherein treating said surface of said mold part comprises forming a hydrophobic surface layer on said surface of said mold part by initiating a reaction of hydroxyl groups provided on said surface and perfluorinated ethoxy alkyl silanes.

15. The method of claim 14, wherein treating said surface of said mold part further comprises at least one of creating and activating said hydroxyl groups on said surface.

16. The method of claim 15, wherein said creating and activating said hydroxyl groups on said surface is implemented using an oxygen plasma process.

17. The method of claim 13, wherein said polymeric precursor material is a water based organic material and includes at least one of PEG, gelatins, PPF (polypropylenefumarate) and PEDOT (Poly(3,4-ethylenedioxythiophene) poly(styrenesulfonate).

18. A mold assembly configured to form a polymer microstructure, said mold assembly comprising:
a first mold part that includes a first organic material and a first surface;
a second mold part that includes a second organic material and a second surface; and
a hydrophobic surface layer formed on at least one of said first and second surfaces having and providing a contact angle configured to suppress residual polymer material during imprinting.

19. The mold assembly of claim 18, wherein said first and second mold parts are patterned.

20. The mold assembly of claim 18, wherein one of said first and second mold parts is made of PDMS.
